(19) United States
(12) Patent Application Publication
(10) Pub. No.: US 2012/0284026 A1
(43) Pub. Date: Nov. 8, 2012

(54) SPEAKER VERIFICATION SYSTEM

(75) Inventors: Peter S. Cardillo, Atlanta, GA (US); Marsal Gavalda, Sandy Springs, GA (US)

(73) Assignee: Nexidia Inc., Atlanta, GA (US)

(21) Appl. No.: 13/102,175

(22) Filed: May 6, 2011

(51) Int. Cl. G10L 17/00

(52) U.S. Cl. 704/246; 704/E17.001

(57) ABSTRACT

In an aspect, in general, a method for computer assisted speaker authentication in a voice communication session includes establishing a voice communication session between a first speaker and an agent, accepting a first voice signal from the first speaker, determining a voice characteristic measure of the first voice signal, including characterizing a similarity of the first voice signal to each of one or more stored characterizations of voice signals previously acquired from one or more known speakers, and providing an interface to the agent during the voice communication session between the agent and the first speaker, including presenting an indicator based on the determined voice characteristic measure to the agent.

### BACKGROUND

This invention relates to a speaker verification system, and more particularly the use of a speaker verification system in voice communications.

Telephone communications between institutions such as businesses, hospitals, banks, and their clients are commonly used to conduct transactions or resolve customer service issues that exist between the institutions and the clients. In general it is important to the institutions that their clients feel satisfied with the customer service that they receive and that any communications between the institutions and the clients maintain the clients' privacy and secure their personal and financial information.

Many institutions include call centers (e.g., a customer service call center) that handle telephone calls from clients. Such call centers often strive to provide a satisfactory customer experience by using information such as caller identification information to determine the identity of a client on a call and use it to improve the client's experience by quickly and automatically accessing the client's records and/or calling the client by their first name.

Furthermore, institutions such as hospitals and banks often use telephone conversations to communicate sensitive information such as medical records and financial transactions. For such institutions, it is imperative that the identity of the client is verified as authentic before any information or transactions are communicated. For example, an identity thief may try to commit fraud by assuming the identity of a client of a bank by calling the bank and impersonating the client. If the bank doesn't identify the thief as an impostor, both the client and the bank may suffer consequences such as financial losses, loss of privacy, and/or diminished credit rating.

For this reason, institutions such as hospitals and banks often implement fraud protection measures that seek to verify that a caller is who they say they are. In some examples, fraud protection measures can include asking the caller a number of challenge questions that, in theory, only the client would know the answers to. In other examples, the transactions requested by the caller may be analyzed and compared to the typical transaction behavior of the client for the purpose of identifying anomalous behavior.

### SUMMARY

In an aspect, in general, a method for computer assisted speaker authentication in a voice communication session includes establishing a voice communication session between a first speaker and an agent, accepting a first voice signal from the first speaker, determining a voice characteristic measure of the first voice signal, including characterizing a similarity of the first voice signal to each of one or more stored characterizations of voice signals previously acquired from one or more known speakers, and providing an interface to the agent during the voice communication session between the agent and the first speaker, including presenting an indicator based on the determined voice characteristic measure to the agent.

Aspects may include one or more of the following features.

The method may include determining an ostensible identity of the first speaker based on information acquired from the first speaker. The method may include soliciting the information acquired from the first speaker. The method may include passively determining the information acquired from the first speaker during the voice communication session with the first speaker. Determining the voice characteristic measure of the first voice signal may include characterizing a similarity of the first voice signal to a stored characterization corresponding to the determined ostensible identity. The voice characteristic measure may be used to flag the voice communication session for later analysis.

The method may include determining an identity of the first speaker, the identity based on the voice characteristic measure. Determining the identity of the first speaker may include determining a plurality of challenge questions. A number of the challenge questions asked may depend on the voice characteristic measure. The indicator may include a binary indicator. The binary indicator may represent whether the voice characteristic measure of the first voice signal is likely included in the one or more stored characterization of voice signals. The indicator may include a picture of the first speaker.

The indicator may include a name of the first speaker. The indicator may include a score representing of the similarity of the first speaker and one of the one or more known speakers. The voice characteristic measure may be updated as the voice communication session progresses. A speaker model of one or more speaker models may be associated with each of the one or more previously acquired voice signals and determining the voice characteristic measure further may include applying the one or more speaker models to the first voice signal.

The one or more speaker models may be updated based on voice signals accepted during the voice communication session. A new speaker model may be generated if no speaker model is associated with the first voice signal. The voice communication session may include a telephone communication session.

In another aspect, in general, a system for computer assisted speaker authentication in a voice communication session includes a communication network, a speaker verification module, a storage for measured voice characteristics, and a user interface. The system is configured to establish a voice communication session between a first speaker and an agent, accept a first voice signal from the first speaker, determine a voice characteristic measure of the first voice signal, including using the speaker verification module to characterize a similarity of the first voice signal to each of one or more characterizations of voice signals previously acquired from one or more known speakers and stored in the storage for measured voice characteristics, and update the user interface during the voice communication session between the agent and the first speaker, including presenting an indicator based on the determined voice characteristic measure to the agent.

Aspects may include one or more of the following features.

The system may be further configured to determine an ostensible identity of the first speaker based on information acquired from the first speaker. The system may be further configured to solicit the information acquired from the first speaker. The system may be further configured to passively determine the information acquired from the first speaker during the voice communication session with the speaker. Determining the voice characteristic measure of the first voice signal may include characterizing a similarity of the first voice signal to a stored characterization corresponding to the determined ostensible identity. The system may be further configured to use the voice characteristic measure to flag the voice communication session for later analysis.

The system may be further configured to determine an identity of the first speaker, the identity based on the voice characteristic measure. Determining the identity of the first speaker may include determining a plurality of challenge questions. A number of challenge questions asked may depend on the voice characteristic measure. The indicator may include a binary indicator. The binary indicator may represent whether the voice characteristic measure of the first voice signal is likely included in the one or more stored characterization of voice signals. The indicator may include a picture of the first speaker. The indicator may include a name of the first speaker. The indicator may include a score representing of the similarity of the first speaker and one of the one or more known speakers.

The system may be further configured to update the voice characteristic measure as the voice communication session progresses. A speaker model of one or more speaker models may be associated with each of the one or more previously acquired voice signals and determining the voice characteristic measure may include applying the one or more speaker models to the first voice signal. The one or more speaker models may be updated based on voice signals accepted during the voice communication session. A new speaker model may be generated if no speaker model is associated with the first voice signal. The voice communication session may include a telephone communication session.

In another aspect, in general, a system for computer assisted speaker authentication in a voice communication session includes a call center. The call center includes a speaker verification module, a data storage configured to store a plurality of known voice characteristic measures, and a user interface configured to present identity information to the agent. The call center is configured to establish a voice communication session between a first speaker and an agent, accept a first voice signal from the first speaker, determine a voice characteristic measure of the first voice signal, including characterizing a similarity of the first voice signal to each of one or more characterizations voice signals previously acquired from one or more known speakers and stored in the data storage, determine an identity of the first speaker using the speaker verification module, the identity dependent on the voice characteristic measure, and present the identity of the first speaker to the agent during the voice communication session using the user interface.

Aspects may include one or more of the following features.

Determining the identity of the first speaker may include determining an authentication measure dependent on the voice characteristic measure and presenting the identity of the first speaker to the agent may include presenting an authenticity indication dependent on the authentication measure. Determining the identity of the first speaker may include the agent asking the first speaker a plurality of challenge questions. The number of challenge questions included in the plurality of challenge questions may vary according to the authentication measure.

The authenticity indicator may be a binary indicator. The authenticity indicator may be an authenticity score. The agent may augment the authentication measure by listening to the first voice signal and one or more of the stored voice signals. The authentication measure may update continuously as the voice communication session progresses. The voice communication session may be a telephone communication session. A speaker model of one or more speaker models may be associated with each of the one or more previously acquired voice signals and determining the voice characteristic measure may include applying the one or more speaker models to the first voice signal. The one or more speaker models may be updated based on voice signals accepted during the voice communication session.

In another aspect, in general, a method for computer assisted speaker authentication of a voice communication session includes establishing a voice communication session between a first speaker and an agent, determining an ostensible identity of the first speaker based on information solicited from the first speaker, accumulating a voice communication session between a first speaker and an agent including accepting a first voice signal from the first speaker, terminating the voice communication session, analyzing the accumulated voice communication session including determining a voice characteristic measure of the first voice signal, including characterizing a similarity of the first voice signal to a stored characterizations of voice signals previously acquired from one or more known speakers, and flagging the accumulated voice communication session for further analysis based on the voice characteristic measure.

Other features and advantages of the invention are apparent from the following description, and from the claims.

### DESCRIPTION OF DRAWINGS

FIG. 1 shows a caller communicating call center including speaker verification.

FIG. 2 shows a caller communicating with a call center including fraud protection and speaker verification.

FIG. 3 shows a graphical user interface.

### DESCRIPTION

### 1 Overview

The following description relates to speaker verification systems and their uses in the context of voice communication sessions.

Voice communication sessions, such as telephone conversations, are commonly used as a convenient way to transmit information between two or more parties. In some examples, telephone conversations can be used by institutions such as businesses, to provide customer service to their clients. In other examples, entities such as banks and hospitals can use telephone conversations to communicate sensitive information such as financial and medical information to their clients.

As was previously mentioned, call centers providing these types of services often use varying levels of identity verification to determine which client is on the telephone and if the client really is who they say they are (e.g., not an impostor). However, these conventional methods are still susceptible to impostors spoofing information (e.g., spoofing caller identification information) and obtaining and using personal information (e.g., learning the answers to challenge questions). Thus, there is a need for more robust speaker verification systems.

In conventional call centers, communication is generally established between a client and a representative of an institution by one of the entities initiating a telephone call. The representative of the institution is generally seated in front of a computer system that allows them to access the client's records.

At the beginning of the telephone communication, the computer system may utilize some information provided by a telephone network (e.g., caller identification information) to quickly identify the client and recall their records for use by the representative. If information such as caller identification information isn't available, the representative may ask a set of introductory questions (e.g., name, address, etc) to the client in order to obtain enough information to access the client's records. Once the representative has access to the client's records, they are able to process the client's requests.

The following discussion includes examples of call centers that augment conventional call center systems by using speaker verification to accurately identify the caller in a telephone conversation.

### 2 Customer Service Applications

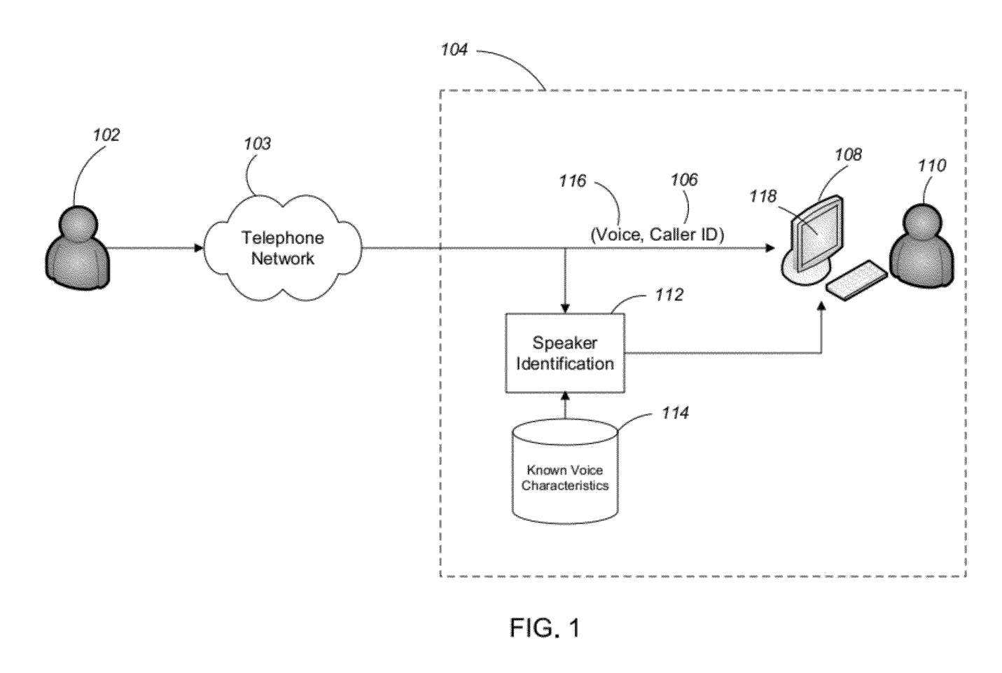

Referring to FIG. 1, in some examples, when a caller 102 calls into a call center 104, the caller identification information 106 provided to the computer system 108 is associated with a number of different clients. For example, three people living in a household may all order products from a business using the same home phone number. In a conventional call center, a representative 110 has no way of knowing which of the three clients is calling based solely on the caller identification information 106 that is provided by the network 103. Thus, the representative 110 needs to inquire which of the three clients from the household is calling. This step can cost the representative 110 time and the client's experience may be adversely affected because the representative 110 did not automatically know them by name. This problem can be overcome by the use of a speaker verification module 112 to indicate to the representative 110 which client they are likely speaking to.

When a client 102 first contacts the representative 110, a recording of the client's voice can be made and characterized. The characterization can be stored in a database of known voice characteristics 114 that are associated with a specific caller identification information 106 (i.e., the client is enrolled). In some examples, both the voice characterization and the voice signal are stored in the database 114. When a telephone call is received by the call center 104, the computer 108 searches the database of known voice characteristics 114 for known voice characteristics that match the caller identification information 106 of the caller 102. If one or more known voice characteristics in the database 114 are associated with the caller identification information 106 of the caller 102, they are used by the speaker verification module 112 to analyze the caller's voice 116 and determine whether or not the caller's voice 116 has the same voice characteristics as one of the known voice characteristics.

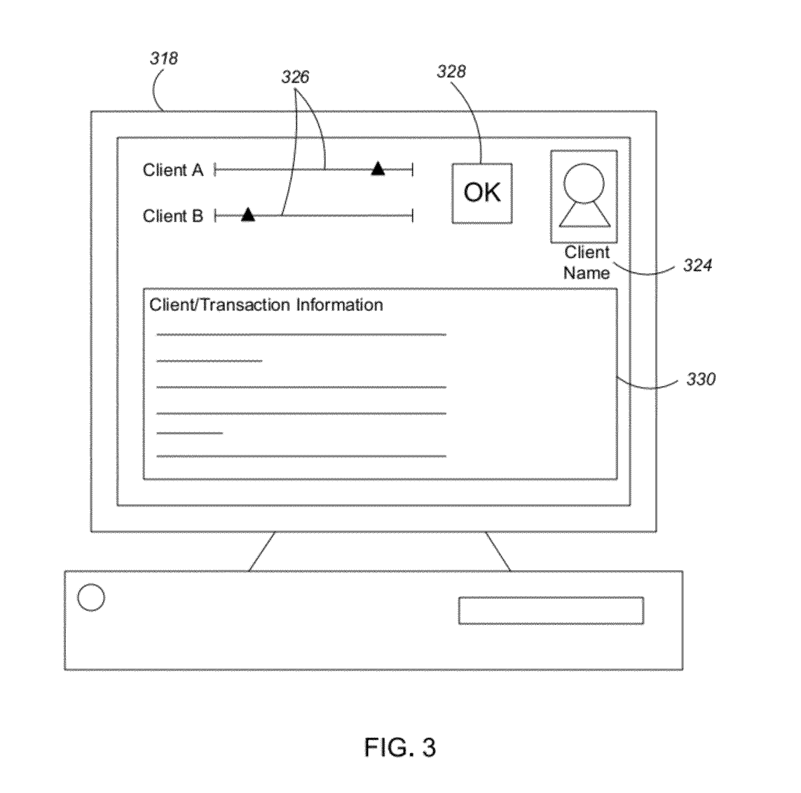

Referring to FIG. 3, if a match is found, the representative 110 can be notified of the name 324 of the caller 102 through a user interface 318 such that they can refer to the caller 102 by name 324. In some examples, client and/or transaction information 330 can also be automatically recalled for the representative 100 to use. Furthermore, a representation of the quality of the match between the caller's voice 116 and the stored version of one or more client's voices can be displayed to the representative 100 (e.g., indicators 326).

If no match for the caller's voice characteristics is found in the database 114, the representative 110 can be notified that the caller 102 is likely a new client and a recording of the caller's voice 116 can be made and stored in the database of known voice characteristics 114 for later use.

### 3 Fraud Protection Applications

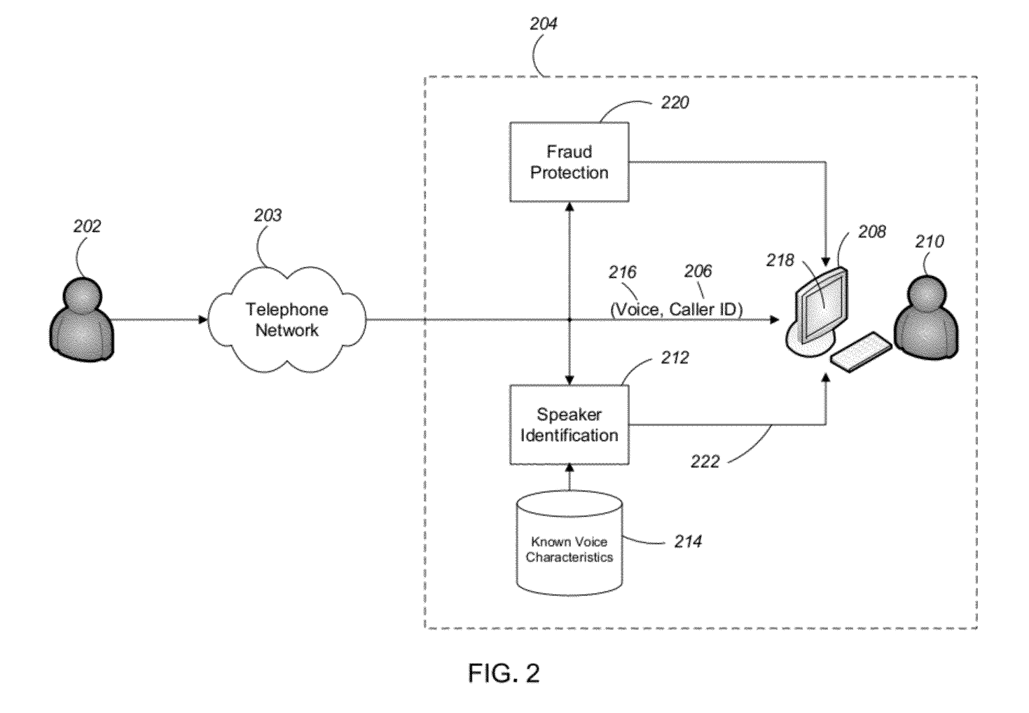

Referring to FIG. 2, a client (or someone impersonating the client) 202 places a call over a telephone network 203 to a call center 204, for example, in a banking institution. In some examples, the agent 210 uses the caller ID information 206 of the caller 202 to determine the ostensible name of the caller 202. In other examples, the agent 210 determines the ostensible name of the caller 202 by asking the caller 202 for their name or account number. Such institutions are generally cautious about providing unauthorized access to their client's accounts and their call centers 204 often utilize some form of fraud protection 220. In some examples, the fraud protection 220 includes the representative 210 asking the caller a number of challenge questions that, in theory, only the authorized client 202 can answer correctly. In other examples, the fraud protection 220 includes analyzing the account activity requested by the caller 202 and determining whether the account activity is out of the ordinary for the client's account.

As was previously mentioned, the fraud protection 220 used by the institution may be susceptible to malicious parties such as identity thieves circumventing the protection. For example, a malicious party impersonating the client 202 may know their bank account number as well as the answers to their challenge questions. To augment the fraud protection 220 already used by the call center 204, a speaker verification module 212 can be used to compare characteristics of the caller's voice 216 to known characteristics of the authorized client's voice stored in a known voice characteristics database 214. In some examples, the known characteristics are created by recording the authorized client's voice 216 when the account is created. The recording can be characterized and stored in the known voice characteristics database 214, associated with parameters such as the client's account number or name (i.e., the client is enrolled). In some examples, the recorded voice signal can also be stored in the database 214.

Again referring to FIG. 3, the speaker verification module 212 can generate a score 222 that indicates how closely the caller's voice 216 matches the known authorized client's voice. The score 222 can be presented to the representative 210 in real time through a user interface 318 (e.g., as indicators 326) and the representative 210 can use the score 222 to make a determination as to whether the caller 202 is authorized to access the client's account. In other examples, the user interface 318 can automatically analyze the score 222 and if the score 222 is less than a predetermined value, flag the transaction for later review. In some examples, based on the analyzed score the user interface 318 can present an OK or NOK indicator 328 to the representative 110 such that the representative 110 can easily discern the authenticity of the caller.

In an alternative example, the client (or someone impersonating the client) 202 places a call over the telephone network 203 to the call center 204. The agent 210 then determines the ostensible identity of the caller 202. In some examples, the agent 210 actively determines the ostensible identity of the caller 202 by, for example, directly asking the caller 202 for information such as their name or account number. In other examples, the agent 210 passively determines the ostensible identity of the caller 202 by, for example, processing the caller ID information 206 of the caller 202 using a customer relations management (CRM) system or processing a name or account number entered by the caller 202 using an interactive voice response (IVR) system. At the same time, the entire conversation between the agent 210 and the caller 202 is recorded. After the call ends, the recorded conversation and the ostensible identity of the caller 202 are sent to the speaker verification module 212 which generates a score 222 that indicates how closely the caller's voice 216 matches the known authorized client's voice. If the score 222 is less than a predetermined value, the call is flagged for later review or action.

### 4 Speaker Verification Module

The speaker verification module 112, 212 can utilize a number of different speaker verification methods to determine the similarity of the caller's voice characteristics to the client's known s voice characteristics.

As was previously mentioned, a client's voice characteristics must first be enrolled into a database of known voice characteristics associated with the speaker verification module. The enrollment process includes recording the client's voice and extracting a voice print, template, or model of the client's voice which can be stored in the database of known voice characteristics.

In some examples, when a call is received, the call center 204 first determines if a speaker model for the caller 202 already exists (e.g., in the database 214). If no speaker model currently exists for the caller 202, a speaker model is automatically created from the present call and stored for use in future calls. If it is determined that a speaker model already exists for the caller 202, the previously described speaker verification steps are performed. If the result of the speaker verification steps indicates that the caller's 202 voice matches the authorized client's voice, the call can be used to further train the existing speaker model.

When a caller's voice is identified by the speaker verification module, the caller's voice is compared against the previously extracted voice print, template, or model of the known client's voice.

In some examples, the words spoken in the enrollment of the client's voice characteristics are the same words that are used by the speaker verification module. For example, a client must enroll their voice using a pass phrase and they must speak that pass phrase each time they call the call center for verification purposes. In other examples, the words used during the enrollment process can differ from those used in verifying a caller's identity.

A number of technologies exist for speaker verification. For example, processing and storing voice prints can be accomplished by frequency estimation, pattern matching algorithms, hidden Markov models, neural networks, and decision trees. These technologies are well known in the art and will not be discussed further in this application.

### 5 Alternatives

In some examples, the score generated by the speaker verification module can be used to determine the number of challenge questions that the representative should ask a caller. For example, a high speaker verification score can cause the user interface to indicate that the representative should ask only two challenge questions while a low speaker verification score can cause the user interface to indicate that the representative should ask 10 challenge questions to the caller.

In some examples, an institution such as a bank may flag any transactions including voices that it determines are anomalous and review a predetermined number of flagged transactions at the end of the day. For example, the bank may flag 10,000 transactions on a given day and review the 500 flagged transactions with the lowest speaker verification scores.

In some examples, when a caller's voice produces a poor voice verification score the representative may be alerted and given the option to listen to previously recorded versions of the client's voice for the purpose of comparing the caller's voice to the known client's voice.

In some examples, the speaker verification score may dynamically change as the telephone conversation progresses.

In some examples, each telephone conversation between a client and a call center can further train a speaker model, causing the speaker verification module to be continuously refined.

It is to be understood that the foregoing description is intended to illustrate and not to limit the scope of the invention, which is defined by the scope of the appended claims. Other embodiments are within the scope of the following claims.

What is claimed is:

1. A method for computer assisted speaker authentication in a voice communication session, the method comprising:
establishing a voice communication session between a first speaker and an agent;
accepting a first voice signal from the first speaker;
determining a voice characteristic measure of the first voice signal, including characterizing a similarity of the first voice signal to each of one or more stored characterizations of voice signals previously acquired from one or more known speakers; and
providing an interface to the agent during the voice communication session between the agent and the first speaker, including presenting an indicator based on the determined voice characteristic measure to the agent.

2. The method of claim 1 further comprising determining an ostensible identity of the first speaker based on information acquired from the first speaker.

3. The method of claim 2 including soliciting the information acquired from the first speaker.

4. The method of claim 2 including passively determining the information acquired from the first speaker during the voice communication session with the first speaker.

5. The method of claim 2 wherein determining the voice characteristic measure of the first voice signal further includes characterizing a similarity of the first voice signal to a stored characterization corresponding to the determined ostensible identity.

6. The method of claim 1 further comprising using the voice characteristic measure to flag the voice communication session for later analysis.

7. The method of claim 1 further comprising determining an identity of the first speaker, the identity based on the voice characteristic measure.

8. The method of claim 2 wherein determining the identity of the first speaker includes determining a plurality of challenge questions.

9. The method of claim 8 wherein a number of the challenge questions asked depends on the voice characteristic measure.

10. The method of claim 1 wherein the indicator includes a binary indicator.

11. The method of claim 10 wherein the binary indicator represents whether the voice characteristic measure of the first voice signal is likely included in the one or more stored characterization of voice signals.

12. The method of claim 1 wherein the indicator includes a picture of the first speaker.

13. The method of claim 1 wherein the indicator includes a name of the first speaker.

14. The method of claim 1 wherein the indicator includes a score representing of the similarity of the first speaker and one of the one or more known speakers.

15. The method of claim 1, wherein the voice characteristic measure is updated as the voice communication session progresses.

16. The method of claim 1, wherein a speaker model of one or more speaker models is associated with each of the one or more previously acquired voice signals and determining the voice characteristic measure further includes applying the one or more speaker models to the first voice signal.

17. The method of claim 16, wherein the one or more speaker models are updated based on voice signals accepted during the voice communication session.

18. The method of claim 16 wherein a new speaker model is generated if no speaker model is associated with the first voice signal.

19. The method of claim 1 wherein the voice communication session includes a telephone communication session.

20. A system for computer assisted speaker authentication in a voice communication session, the system comprising:
a communication network;
a speaker verification module;
a storage for measured voice characteristics;
a user interface;
wherein the system is configured to
establish a voice communication session between a first speaker and an agent,
accept a first voice signal from the first speaker,
determine a voice characteristic measure of the first voice signal, including using the speaker verification module to characterize a similarity of the first voice signal to each of one or more characterizations of voice signals previously acquired from one or more known speakers and stored in the storage for measured voice characteristics, and
update the user interface during the voice communication session between the agent and the first speaker, including presenting an indicator based on the determined voice characteristic measure to the agent.

21. The system of claim 20 wherein the system is further configured to determine an ostensible identity of the first speaker based on information acquired from the first speaker.

22. The system of claim 21 wherein the system is further configured to solicit the information acquired from the first speaker.

23. The system of claim 21 wherein the system is further configured to passively determine the information acquired from the first speaker during the voice communication session with the speaker.

24. The system of claim 21 wherein determining the voice characteristic measure of the first voice signal further includes characterizing a similarity of the first voice signal to a stored characterization corresponding to the determined ostensible identity.

25. The system of claim 20 wherein the system is further configured to use the voice characteristic measure to flag the voice communication session for later analysis.

26. The system of claim 20 wherein the system is further configured to determine an identity of the first speaker, the identity based on the voice characteristic measure.

27. The system of claim 26 wherein determining the identity of the first speaker includes determining a plurality of challenge questions.

28. The system of claim 27 wherein a number of challenge questions asked depends on the voice characteristic measure.

29. The system of claim 20 wherein the indicator includes a binary indicator.

30. The system of claim 29 wherein the binary indicator represents whether the voice characteristic measure of the first voice signal is likely included in the one or more stored characterization of voice signals.

31. The system of claim 20 wherein the indicator includes a picture of the first speaker.

32. The system of claim 20 wherein the indicator includes a name of the first speaker.

33. The system of claim 20 wherein the indicator includes a score representing of the similarity of the first speaker and one of the one or more known speakers.

34. The system of claim 20, wherein the system is further configured to update the voice characteristic measure as the voice communication session progresses.

35. The system of claim 20, wherein a speaker model of one or more speaker models is associated with each of the one or more previously acquired voice signals and determining the voice characteristic measure further includes applying the one or more speaker models to the first voice signal.

36. The system of claim 20, wherein the one or more speaker models are updated based on voice signals accepted during the voice communication session.

37. The method of claim 35 wherein a new speaker model is generated if no speaker model is associated with the first voice signal.

38. The system of claim 20 wherein the voice communication session includes a telephone communication session.
establishing a voice communication session between a first speaker and an agent;
determining an ostensible identity of the first speaker based on information solicited from the first speaker;
accumulating a voice communication session between a first speaker and an agent including accepting a first voice signal from the first speaker;
terminating the voice communication session;
analyzing the accumulated voice communication session including determining a voice characteristic measure of the first voice signal, including characterizing a similarity of the first voice signal to a stored characterizations of voice signals previously acquired from one or more known speakers; and
flagging the accumulated voice communication session for further analysis based on the voice characteristic measure.
